(19) United States
(12) Patent Application Publication
(10) Pub. No.: US 2016/0182561 A1
(43) Pub. Date: Jun. 23, 2016

(54) ROUTE MONITORING SYSTEM FOR A COMMUNICATION NETWORK

(71) Applicant: Level 3 Communications, LLC, Broomfield, CO (US)

(72) Inventors: John Sherwood Reynolds, II, Westminster, CO (US); Lynn Bilger, Englewood, CO (US)

(73) Assignee: Level 3 Communications, LLC, Broomfield, CO (US)

(21) Appl. No.: 14/575,405

(22) Filed: Dec. 18, 2014

(51) Int. Cl. H04L 29/06; H04L 12/26; H04L 12/24; H04L 12/707

(52) U.S. Cl. CPC H04L 63/1466; H04L 45/22; H04L 43/10; H04L 41/0686

(57) ABSTRACT

A route monitoring system disclosed herein includes a computing system executing a route monitoring service coupled to a communication network. The route monitoring service receives a route redirection message from one or more network elements in a communication network, and compares the route update information against one or more normalcy rules associated with potential malicious route redirecting mechanisms. The route redirection message includes route update information defining a change to a route through the communication network. When the comparison of the route update information to the one or more normalcy rules identifies a malicious route redirection attack, the service generates one or more remedial actions to mitigate the redirection attack.

### TECHNICAL FIELD

Aspects of the present disclosure relate to communication networks and, in particular, to a route monitoring system for a communication network.

### BACKGROUND

Routing of packets in packet-based networks, such as the Internet, typically function according to a standardized protocol, such as a border gateway protocol (BGP). The BGP is generally used to exchange routing and reachability information between network elements (NEs) on the network that they serve. The BGP makes decisions based on paths, network policies and/or rules that may be configured automatically or manually by one or more network administrators. Additionally, the BGP protocol plays a key role in the overall operation of many packet-based communication networks and is involved in making core routing decisions.

Although the BGP has served intended use well, it possesses vulnerabilities to attack by the manner in which route redirection occurs. That is, advertisement messages, which may be used to initiate a route redirection, may also be used to initiate a malicious route redirection that is sometimes referred to as a man-in-the-middle (MITM) attack. The MITM attack generally involves a form of eavesdropping in which the attacker makes independent connections with a route of a victim and relays messages between the victim, thus making the victim believe that it is communicating properly, when in fact the entire conversation is controlled by an attacker who initiated the MITM attack. It is with these observations in mind that embodiments of the present disclosure have been developed.

### SUMMARY

According to one embodiment of the present disclosure, a route monitoring system disclosed herein includes a computing system executing a route monitoring service coupled to a communication network. The route monitoring service receives a route redirection message from one or more network elements in a communication network, and compares the route update information against one or more normalcy rules associated with potential malicious route redirecting mechanisms. The route redirection message includes route update information defining a change to a route through the communication network. When the comparison of the route update information to the one or more normalcy rules identifies a malicious route redirection attack, the service generates one or more remedial actions to mitigate the redirection attack.

According to another embodiment, a route monitoring method for a communication network includes receiving a route redirection message from a network element in a communication network, and comparing, using the at least one processor, the route update information against one or more normalcy rules associated with potential malicious route redirecting mechanisms in which the route redirection message includes route update information defining a change to a route through the communication network. From this comparison, the method generates one or more remedial actions when the comparison of the route update information to the one or more normalcy rules identifies a malicious route redirection attack.

According to yet another embodiment, code that includes instructions stored on a computer-readable medium that may be executed to receive a route redirection message from a network element in a communication network in which the route redirection message including route update information defining a change to a route through the communication network. The code may be further executed to compare the route update information against one or more normalcy rules associated with potential malicious route redirecting mechanisms, and generate one or more remedial actions when the comparison of the route update information to the one or more normalcy rules identifies a malicious route redirection attack.

### BRIEF DESCRIPTION OF THE DRAWINGS

The foregoing and other objects, features and advantages of the disclosure will be apparent from the following description of particular embodiments of the disclosure, as illustrated in the accompanying drawings in which like reference characters refer to the same components throughout the different views. The drawings are not necessarily to scale, emphasis instead being placed upon illustrating the principles of the disclosure.

FIG. 1A is a block diagram of an example communication network that implements a route monitoring system according to one aspect of the present disclosure.

FIG. 1B depicts an example network element according to one aspect of the present disclosure.

FIG. 1C depicts an example data source according to one aspect of the present disclosure.

FIG. 2 depicts a diagram of an example communication service provider (CSP) computing system according to one aspect of the present disclosure.

FIG. 3 is a flowchart depicting an example process that may be performed by the route monitoring system according to one aspect of the present disclosure.

FIG. 4 illustrates an example computer system according to one embodiment of the present disclosure.

FIG. 5 illustrates an example user interface screen that may be generated by the route monitoring service to verify the autonomous system numbers (ASNs) included in an autonomous system (AS) path list in the network field portion of a BGP route.

FIG. 6 illustrates an example user interface screen that may be generated by the route monitoring service to show one or more route redirection messages that have been determined to include malicious route redirection attacks.

FIG. 7 illustrates an expanded view of the inspect/edit screen portion of the user interface screen of FIG. 5.

### DETAILED DESCRIPTION

A route monitoring system described herein may continually monitor a communication network to identify malicious route redirection attacks, and perform one or more remedial actions to alleviate or reduce the effects of those attacks. In particular, the system may access route redirection messages, such as border gateway protocol (BGP) update messages, that are normally used during operation of a packet-switched network (e.g., the Internet), and compare information included in the route redirection messages against one or more rules to determine whether any of the route redirection messages comprises malicious route redirection messages from which remedial actions may be administered.

In publicly accessible communication networks, such as the Internet, route redirection messages are commonly used to redirect routes transmitted through the network. In packet-based networks, for example, routes generally include paths that are established between two or more nodes for providing a communication service. For example, routes may be redirected due to a failure or overload condition of a network element (NE), such as a router or switch, that was previously functioning properly. As another example, the BGP protocol, which is commonly used on the Internet, uses advertisement messages to divert routes to enhance network throughput. Nevertheless, advertisement messages may be used to initiate a malicious route redirection that is sometimes referred to as a man-in-the-middle (MITM) attack. The MITM attack involves a form of eavesdropping in which the attacker makes independent connections with a route of a victim and relays messages between the victim, thus making the victim believe that it is communicating properly, when in fact the entire conversation is controlled by an attacker who initiated the MITM attack. For example, a MITM attack may involve an advertisement to a node for a route redirect message request, and if the node accepts, the route is maliciously redirected.

Currently available protection mechanisms for mitigating MITM attacks typically involve DNS updates that resolve routes according to their appropriate source and destination, while discarding inappropriate or otherwise dangling routes. Nevertheless, the scale and breadth of the Internet has limited these DNS updates to occur approximately once every hour. This resolution, however, still leaves a relatively long time for a MITM attack to do significant damage. For example, a MITM attack on a financial institution, such as a credit card processing website, can steal millions of dollars from financial accounts in as little as 5 seconds in some cases. Embodiments described herein provide a solution to this problem, among other problems, using a route monitoring system that tracks route redirection messages in real-time or near real-time to determine whether each route redirection message is valid and if not, perform one or more remedial actions to halt or otherwise curtail the ill effects of the attack.

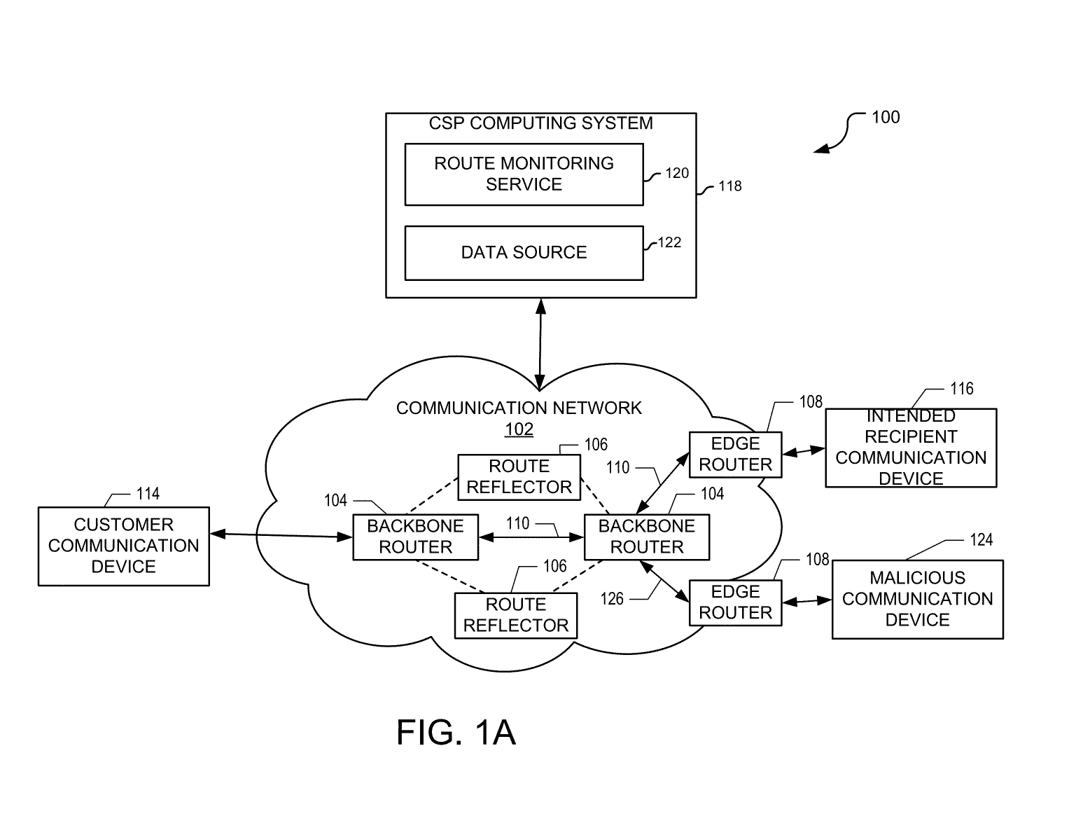

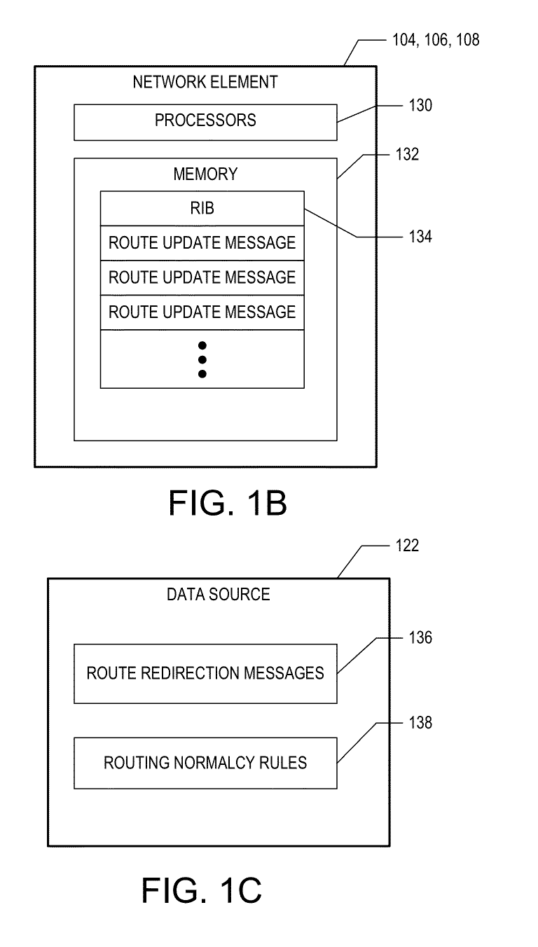

FIGS. 1A through 1C depict an example route monitoring system 100 that may be used to monitor and manage routes of a communication network 102 according to aspects of the disclosure. Although the particular communication network shown herein is a simplified example, it should be understood that an actual network deploying the concepts described herein may have numerous network elements (NEs) and customer devices using the network not specifically shown and described herein.

The communication network 102 has multiple NEs such as backbone routers 104, route reflectors 106, and edge routers 108 that provide a communication route 110 between a client communication device 114 and an intended recipient communication device 116. The system 100 includes a communication service provider (CSP) computing system 118 or other computing device or system that includes a route monitoring service 120 and a data source 122. When a malicious recipient device 124 attempts to redirect the route 110 to a malicious route 126, the route monitoring service 120 detects the malicious attack and performs one or more remedial actions to halt and otherwise mitigate the effects of the malicious route redirecting attempt.

The data source 122 stores route redirection messages 136 received from one or more NEs in the communication network 102, and one or more routing rules 138 that are used by the service 120 to determine whether any of the route redirection messages are malicious. Although the data source 122 is shown as being located on, at, or within the route monitoring computing system 110, it is contemplated that the data source 122 can be located remotely from the CSP computing system 110, such as on, at, or within the memory 134 of one or more network elements 104, 106, 108.

The communication network 102 may be any type that provides communication services using one or more network elements (e.g., backbone routers 104, route reflectors 106, and/or edge routers 108). In one embodiment, the communication network 102 is an Internet Protocol (IP) based communication network, such as a ‘tier 1’ communication network that provides varying types of communication services (e.g., voice, data, and video communication services, etc.).

As depicted in FIG. 1A, an IP based communication network may include backbone routers 104 and edge routers 108 that route packets of the communication route 110 according to one or more routing tables stored in the memory of each backbone router 104 or edge router 108. Route reflectors 106 are typically implemented to provide an ancillary source of routing information to client communication devices 114, the intended recipient device 116, and other devices that may utilize the communication network 102. Nevertheless, it should be understood that the communication network 102 may include other devices not specifically shown herein. For example, other types of network elements may include gateway devices each having a first interface that communicates according to a first protocol, and a second interface that communicates according to a second protocol, such as gateway of a packet-based network that interfaces with a public switched telephone network (PSTN). A typical gateway may have many interfaces communicating over the same and/or different protocols. The gateway device may be, for example, an ingress network element and/or egress network element that receive packets from or transmits packet to, respectively, a client communication device.

The client communication device 114 and intended communication device 116 may be any type that is configured to communicate with the communication network 102 using protocols established for the communication network. For a communication network such as an IP based communication network, the client communication device 114 communicates with the intended recipient communication device 116 by transmitting and receiving IP based packets that are routed through the communication network 102 along the communication route 110. In one embodiment, the client communication device 114 and/or intended recipient communication device 116. Each of the client communication device 114 and intended recipient communication device 116 has one or more processors and executable instructions stored in volatile and/or non-volatile memory for performing the actions and/or steps described herein.

FIG. 1B depicts an example network element 104, 106, 108 according to one aspect of the route monitoring system 100. The network element 104, 106, 108 includes a computing or processing device that includes one or more processors 130 and memory 132 and is to receive data and/or communications from, and/or transmit data and/or communications to, the CSP computing system 110 via wireless, wired, and/or optical communications.

The memory stores a routing information base (RIB) 134 (e.g., routing table) that directs packets received by its respective NE to another NE based upon destination information included in the routing table. The RIB 134 may include one or more route redirection messages. In general, the RIB 134 is a data table stored in a router or other network element that includes one or more routes to particular destinations, and may also include certain metrics associated with the routes. The RIB for each NE may be generated by a negotiation process among all NEs in the network on an ongoing basis at predetermined time intervals. For example, the RIB may be generated every 24 hours and distributed to some, most, or all NEs in the communication network 102. Thereafter, route redirections that occur in the network are stored as route redirection messages. At the next predetermined time interval, the route redirection messages are deleted, and a new RIB is stored that includes an updated record of all routes in the network at that point in time. In one embodiment, the route monitoring service 120 stores route redirection messages in the data source 122 as they are generated to detect malicious route redirection messages.

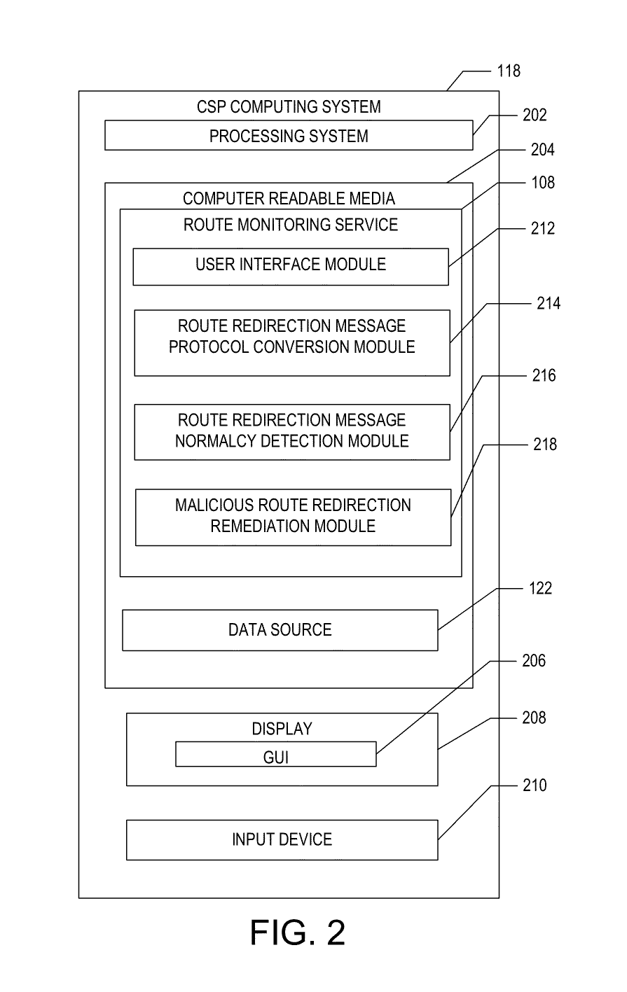

FIG. 2 is a block diagram depicting an example route monitoring service 120 executed on the CSP computing system 118. According to one aspect, the CSP computing system 118 includes a processing system 202 that includes one or more processors or other processing devices. A processor is hardware. Examples of such a computing system include one or more servers, personal computers, mobile computers and/or other mobile devices, and other computing devices. The CSP computing system 118 may communicate with the network elements 104, 106, 108 via wireless, wired, and/or optical communications.

According to one aspect, the CSP computing system 118 includes a computer readable media 204 on which the route monitoring service 120 and data source 122 are stored. The route monitoring service 120 includes instructions or modules that are executable by the processing system 202 to perform the features of the route monitoring system 100 described herein.

The computer readable media 204 may include volatile media, nonvolatile media, removable media, non-removable media, and/or another available media that can be accessed by the CSP computing system 118. By way of example and not limitation, computer readable media 204 comprises computer storage media and communication media. Computer storage media includes non-transient storage memory/media, volatile media, nonvolatile media, removable media, and/or non-removable media implemented in a method or technology for storage of information, such as computer/machine readable/executable instructions, data structures, program modules, and/or other data. Communication media may embody computer readable instructions, data structures, program modules, or other data and include an information delivery media or system.

According to one aspect, the computing system 118 may include a graphical user interface (GUI) 206 displayed on a display 208, such as a computer monitor, for displaying data. The computing system 118 may also include an input device 210, such as a keyboard or a pointing device (e.g., a mouse, trackball, pen, or touch screen) to enter data into or interact with the GUI 206. According to one aspect, the route monitoring service 120 includes instructions or modules that are executable by the processing system 202 as will be described in detail herein below.

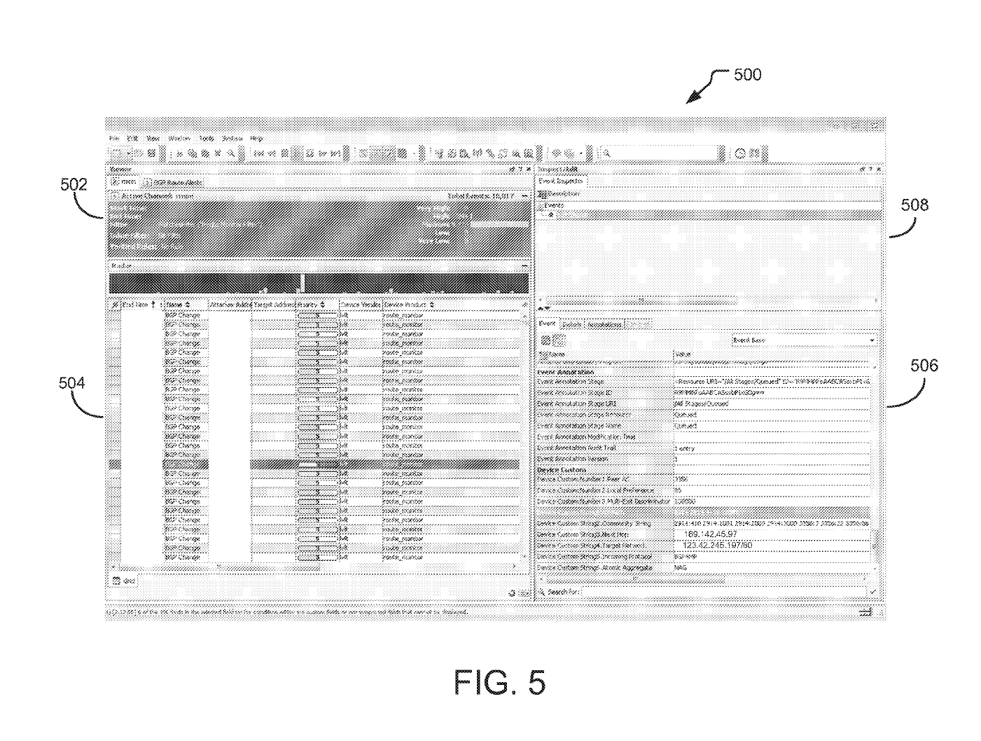

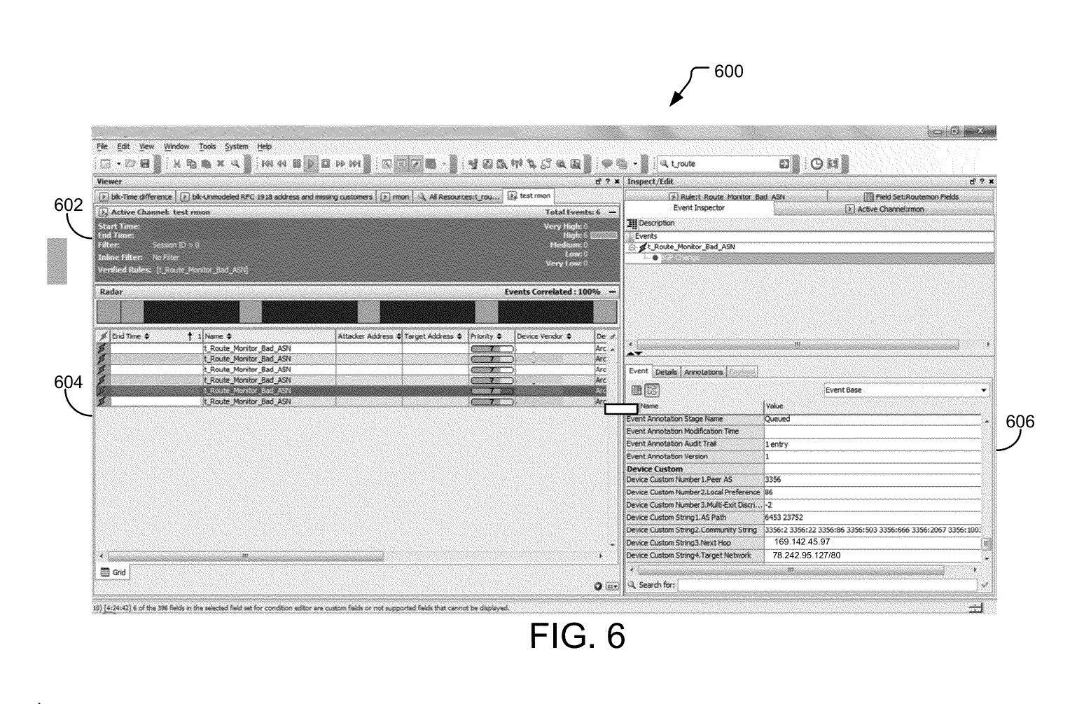

A user interface module 212 facilitates the receipt of input data and/or output data from or to a user, respectively, for manipulating the operation of the system 100. In one example, the user interface module 212 may receive user input for manipulating or otherwise modifying how each rule is applied to detect malicious route redirect attempts. For example, the user interface module 212 may generate an autonomous system number (ASN) rule screen (FIG. 5) that may be used to verify the ASNs included in an autonomous system (AS) path list in the network field portion of a BGP route. For another example, the user interface modules 212 may generate a malicious ASN screen (FIG. 6) showing one or more route redirection messages that has been determined to include malicious route redirection attacks.

A route redirection protocol conversion module 214 converts the format of the received route redirection messages into another format. For example, the route redirection protocol conversion module 214 may convert the route redirection messages from the BGP protocol into an alpha-numeric, comma delimited, string that may be parsed to determine the route redirection information.

A route normalcy detection module 216 analyzes the received route redirection messages to determine whether any of the messages include a malicious route redirection attempt using the routing rules stored in the data source 122. Any suitable type of rule may be used. In one embodiment, one rule may include information associated with known bad IP spaces, such as the Russian Business Network (RBN) IP space. The known bad IP spaces may include, for example, a single IP address, multiple IP addresses, and/or one or more ranges of IP addresses. Known bad IP spaces generally include those domains or range of network addresses that have been known to be sources of malicious network attacks. Additionally, the domains and/or network addresses of known bad IP spaces may change over time based upon movements of malicious attackers within the communication network. In another embodiment, one rule may include information associated with a specific frequency and/or time of occurrence of certain route redirect attempts. For example, the service 120 may generate a rule based upon the daily habits of malicious attackers, such as those who may generate malicious attacks at certain times based upon the time zone in which they live, or due to the attacker's habitual daily routine. In yet another embodiment, one rule may include verifying the ASNs of the AS path list to ensure that the routes are going through valid domains. That is, the service 120 may compare the ASNs associated with each route update message in the RIB 134 with a list of known good ASNs and flag those routes that include ASNs that are not included in the know good list of ASNs.

In one embodiment, each of the rules may be assigned a weighting factor according to their relative impact to the determination of malicious route redirecting attempts. For example, one rule that identifies bad or malicious domains may be given a relatively high weighting factor whereas another rule that performs some less important check may be given a relatively lower weighting factor.

A malicious route redirecting remediation module 218 applies one or more remedial actions to malicious route redirection attempts detected by the system 100. For example, malicious route redirecting remediation module 218 may generate an alarm, such as an audio/visual alarm, or an alert message to certain personnel (e.g., administrators of the network). As another example, the malicious route redirecting remediation module 218 may generate another route redirection message that is distributed to the NEs of the network to cause the malicious route to be directed to a null route (e.g., terminate the route). As another example, the malicious route redirecting remediation module 218 may trigger a tracking procedure that searches for the source of the malicious route redirection attack (e.g., the attacker), such as by examining historical records to determine what domain and/or IP addresses that were used to originate the attack. As yet another example, the malicious route redirecting remediation module 218 may identify entities, such as individuals and/or institutions, who may be affected by the attack, and notify those entities that an attack has occurred so that they may take appropriate action to mitigate the effects of the attack.

It should be appreciated that the modules described herein are provided only as an example of a computing device that may execute the route monitoring service 120 according to the teachings of the present disclosure, and that other computing devices may have the same modules, different modules, additional modules, or fewer modules than those described herein. For example, one or more modules as described in FIG. 2 may be combined into a single module. As another example, certain modules described herein may be encoded and executed on other computing devices, such as the network element used by the user.

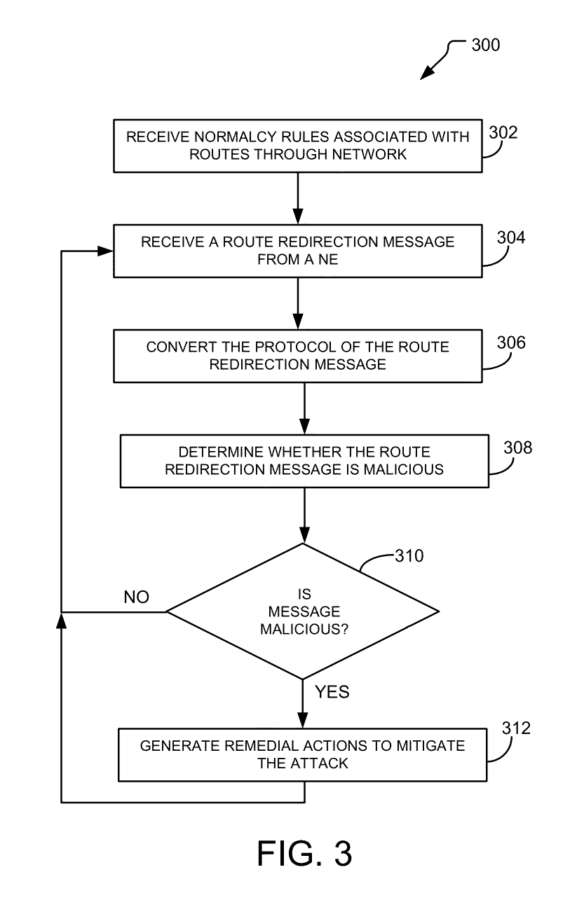

FIG. 3 illustrates an example process that may be performed by the route monitoring service 120 according to the teachings of the present disclosure.

In step 302, the route monitoring service 120 receives routing normalcy rules 138 associated with routes through the network 102. In one embodiment, the routing normalcy rules may be received for any reason, such as replacing a currently existing set of normalcy rules with a different set of normalcy rules. For example, the normalcy rules may be received for changing existing normalcy rules due to an increase and/or decrease of a perceived threat level to the network.

In step 304, the route monitoring service 120 receives an update notification message. The update notification message may be received directly from an NE configured in the network and/or from route redirection messages 136 stored in the data source 122. The NE may be any type that actively routes traffic (e.g., backbone router 104, edge router 108), or may be one that only transmits route information (e.g., route reflector 106). In one embodiment, each NE in the communication network may be configured to transmit any new route update messages stored in its respective RIB to the service 120 as they are generated such that the service may provide monitoring and analysis for the routes through the network on a real-time or near real-time basis.

In step 306, the route monitoring service 120 converts the protocol of the received update notification message to a common format, such as a common event format (CEF), a Java script object notation (JSON) format, or an extensible markup language (XML) format. In one embodiment, the message may be formatted into a form that may be used by a remote procedure call and data serialization framework, such as an APACHE AVRO™ framework. Conversion of the update notification messages to a common format may be useful for implementation of commonly available software applications that may only accept the update notification messages in a specified format.

In step 308, the route monitoring service 120 determines whether the update notification message is a malicious route redirection attack according to the normalcy rules received in step 302. In one embodiment, the route monitoring service 120 may use a security information and event management (SIEM) application that processes route redirection messages against one or more normalcy rules to determine whether update notification messages are malicious, such as the ARCSIGHT™ analytics application, which is available from Hewlett-Packard Incorporation, located in Cupertino, Calif. In a particular example, the route monitoring service 120 may receive an update notification message from a NE that has recently adjusted a route in its respective RIB. In this case, the service 120 may analyze the update notification message against various normalcy rules 138, such as checking whether the ASN associated with the redirected route in included in the list of known good ASNs, whether or not the route is directed to a known bad IP space, and/or the timing of the redirected route indicates a malicious route redirection attempt. In one embodiment, each normalcy rule may be associated with a weighting factor such that the weighted values of multiple normalcy checks may be combined to determine whether the redirected route is malicious or not. If the update notification message is determined to not be malicious, processing continues at step 304 to process the next route redirection message received from an NE in step 310, otherwise processing continues at step 312.

At step 312, the route monitoring service 120 generates one or more remedial actions to mitigate the attack. For example, the route monitoring service 120 may generate an alarm to alert network administrators that a malicious route redirection may have occurred. As another example, the route monitoring service 120 may disable the route until the breach is alleviated. That is, the service 120 may transmit an update notification message back to the affected NE that includes a null route such that the route is effectively disabled. As yet another example, the route monitoring service 120 may notify customers that a breach may have occurred so that they may take additional remedial actions. When the remedial actions have been performed, the route monitoring service 120 continues processing at step 304 for monitoring additional update notification messages through the network. Nevertheless, when use of the route monitoring service 120 is no longer needed or desired, the process ends.

It should be appreciated that the process described herein is provided only as an example and that the route monitoring system 100 may execute additional steps, fewer steps, or differing steps than those described herein. For example, the steps 302 through 312 may be executed in any suitable order; that is, the steps as described in FIG. 3 are not limited to execution in any particular sequence. As another example, either of the steps 302 through 312 described herein may be executed by the CPS computing system 110 or may alternatively be performed by another computing system without departing from the spirit or scope of the present disclosure.

The description above includes example systems, methods, techniques, instruction sequences, and/or computer program products that embody techniques of the present disclosure. However, it is understood that the described disclosure may be practiced without these specific details.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., a diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

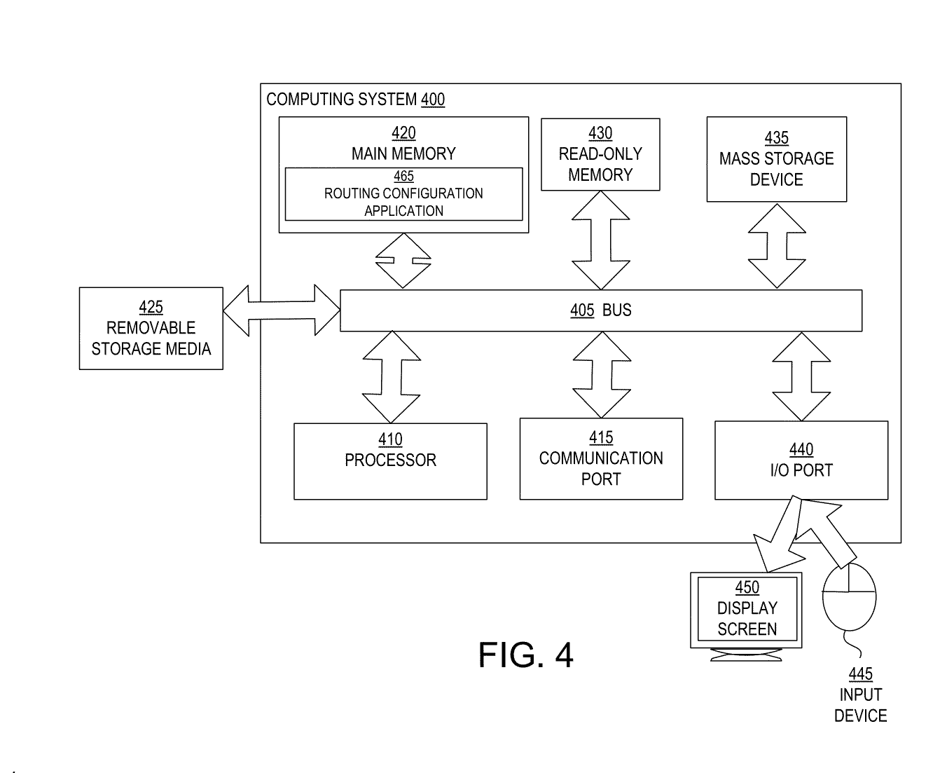

For example, FIG. 4 is a block diagram illustrating an example of a host or computer system 400 which may be used in implementing the embodiments of the present disclosure. The computer system (system) includes one or more processors 402-406. Processors 402-406 may include one or more internal levels of cache (not shown) and a bus controller or bus interface unit to direct interaction with the processor bus 412. Processor bus 412, also known as the host bus or the front side bus, may be used to couple the processors 402-406 with the system interface 414. System interface 414 may be connected to the processor bus 412 to interface other components of the system 400 with the processor bus 412. For example, system interface 414 may include a memory controller 413 for interfacing a main memory 416 with the processor bus 412. The main memory 416 typically includes one or more memory cards and a control circuit (not shown). System interface 414 may also include an input/output (I/O) interface 420 to interface one or more I/O bridges or I/O devices with the processor bus 412. One or more I/O controllers and/or I/O devices may be connected with the I/O bus 426, such as I/O controller 428 and I/O device 430, as illustrated.

I/O device 430 may also include an input device (not shown), such as an alphanumeric input device, including alphanumeric and other keys for communicating information and/or command selections to the processors 402-406. Another type of user input device includes cursor control, such as a mouse, a trackball, or cursor direction keys for communicating direction information and command selections to the processors 402-406 and for controlling cursor movement on the display device.

System 400 may include a dynamic storage device, referred to as main memory 416, or a random access memory (RAM) or other computer-readable devices coupled to the processor bus 412 for storing information and instructions to be executed by the processors 402-406. Main memory 416 also may be used for storing temporary variables or other intermediate information during execution of instructions by the processors 402-406. System 400 may include a read only memory (ROM) and/or other static storage device coupled to the processor bus 412 for storing static information and instructions for the processors 402-406. The system set forth in FIG. 4 is but one possible example of a computer system that may employ or be configured in accordance with aspects of the present disclosure.

According to one embodiment, the above techniques may be performed by computer system 400 in response to processor 404 executing one or more sequences of one or more instructions contained in main memory 416. These instructions may be read into main memory 416 from another machine-readable medium, such as a storage device. Execution of the sequences of instructions contained in main memory 416 may cause processors 402-406 to perform the process steps described herein. In alternative embodiments, circuitry may be used in place of or in combination with the software instructions. Thus, embodiments of the present disclosure may include both hardware and software components.

FIG. 5 illustrates an example screenshot of an ASN rule screen 500 that may be generated by the user interface module 212 of FIG. 2. The ASN rule screen 500 includes a route summary window portion 502, a route update window portion 504, and a route update detail window portion 506, and an inspect/edit screen portion 508.

The route update window portion 504 displays a list of route update messages received by the service 120, while the route summary window portion 502 displays summary information about the routes displayed in the route update window portion 504. For example, the route summary window portion 502 may display information, such as a window of time in which the updated routes associated with the route update messages have occurred, and/or certain NEs that have been assigned to handle the displayed route update messages.

The route update detail window portion 506 displays detail information associated with each route update message displayed in the route update window portion 504. For example, the route update detail window portion 506 may display detail information about a specific route update message that has been selected using an input device, such as mouse that is clicked when its associated pointer is over the specific route update message listed in the route update message window portion 504.

FIG. 6 illustrates an example screenshot of a malicious ASN display screen 600 that may be generated by the user interface module 212 of FIG. 2. The malicious ASN screen 600 generally includes a malicious ASN summary window portion 602, a malicious ASN window portion 604, and a malicious ASN detail window portion 606.

The malicious ASN window portion 604 displays a list of malicious ASNs, which may include, for example, those received via manual entry through the user interface of the system 118. The malicious ASN summary window portion 602 displays summary information about the malicious ASN displayed in the route update window portion 604. The malicious ASN detail window portion 606 displays detail information associated with each malicious ASN message displayed in the malicious ASN window portion 604, such as a malicious ASN displayed in the malicious ASN window portion 604 that has been selected using an input device, such as a mouse.

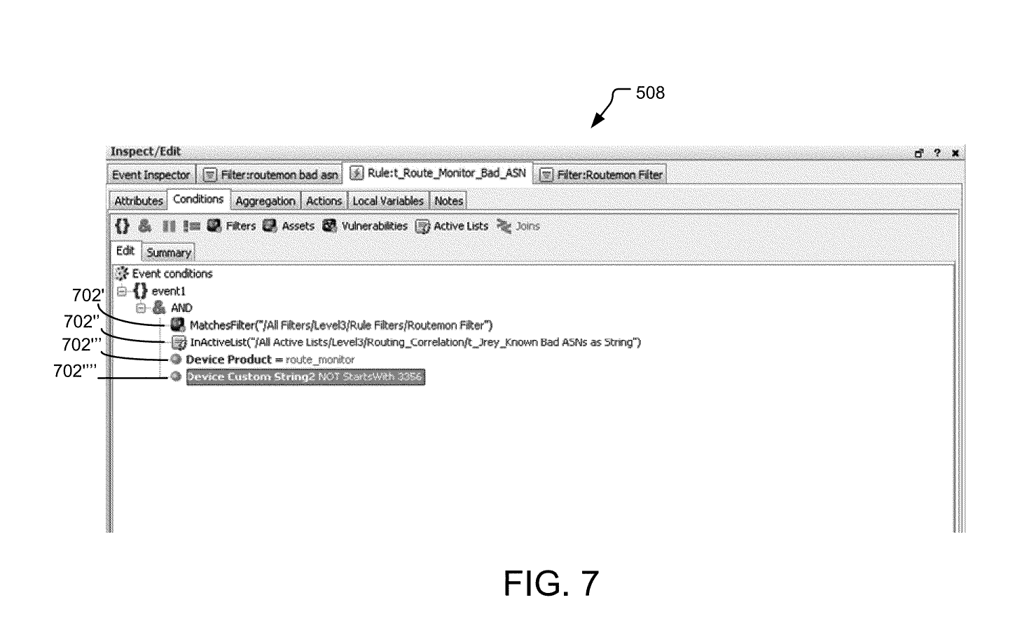

FIG. 7 illustrates an expanded view of the inspect/edit screen portion 508 of the ASN rule screen of FIG. 5. In general, the inspect/edit screen portion provides for display of additional information relative to a selected route update message and editing of normalcy rules that may have affected whether the selected route update message has been determined to be a malicious ASN or not. For the example screenshot shown, the normalcy rules 702 that may be compared against the selected route update message are displayed such that a user may inspect the normalcy values against the selected route update message and edit the displayed normalcy rules if desired. The normalcy rules shown includes a filtering rule 702′, a bad ASN list normalcy rule 702″, a NE identification rule 702′″, and a custom string filtering rule 702″″.

The filtering rules 702′ may be applied to filter against a specified type of route update message. The bad ASN list normalcy rule 702″ compares the selected route update message against a list of known bad ASNs. The NE identification rule 702′″ compares the NE associated with the route update message with a list of know good NEs. The custom string filtering rule 702″″ compares information included in the route update message with a specified alpha-numeric string.

As shown, the malicious ASN display screen 600 may display a list of route update messages that have been determined to be malicious by the one or more normalcy rules. By comparing the malicious ASNs in the malicious ASN display screen 600, users may be provided with information for tailoring the normalcy rules such that most or all route update messages that are actually malicious are identified as being malicious, while other normal route update messages are not identified as malicious. For example, a user analyzing several malicious ASNs in the malicious ASN display screen 600 may observe that, while a particular ASN associated with one or more route update messages may not be directly listed in the known good list of ASNs, other criteria (e.g., frequency, time of occurrence, etc.) associated with the route update messages appears to indicate that the ASN is not bad, but rather is related to another network or other domain that has not yet been identified by the system. In this particular case, therefore, the user may adjust the normalcy rules and/or the weighting factors associated with the normalcy rules such that future processing of route update messages does not flag the identified ASN to be malicious.

Additionally, the ASN rule screen 500 and malicious ASN display screen 600 may be used for other purposes than that described above. For example, if it is determined that a particular route update message is indeed malicious, the user may be prompted to take one or more forms of remedial actions based upon the message, such as modifying the system to generate a null route whenever that ASN is detected and/or transmitting an alert message to customer that uses the affected route.

FIGS. 5 through 7 merely describe examples of displays that may be generated by the user interface 212 of FIG. 2, it should be understood that other types of the displays may be generated without departing from the spirit and scope of the present disclosure. For example, the user interface 212 may display other information associated with the network, such as a list of NEs that a allocated for handling certain routes along with any route redirections that may have occurred over a specified period of time.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

1. A route monitoring system for a communication network, the system comprising:
a communication service provider computing system comprising at least one memory for storing a route monitoring service that is executed by at least one processor to:
receive a route redirection message from a network element in the communication network, the route redirection message including route update information defining a change to a routing rule through the communication network between a customer communication device and a recipient device;
compare the route update information against one or more normalcy rules associated with potential malicious route redirecting mechanisms; and
generate one or more remedial actions when the comparison of the route update information to the one or more normalcy rules identifies a malicious route redirection attack.

2. The route monitoring system of claim 1, wherein the one or more normalcy rules comprise a plurality of normalcy rules, the route monitoring service applying a weighting factor to each normalcy rule, and comparing the route update information with the weighted values of each normalcy rule to identify the route redirection attack.

3. The route monitoring system of claim 1, wherein one of the normalcy rules comprises information associated with known bad IP spaces.

4. The route monitoring system of claim 1, wherein one of the normalcy rules comprises information associated with at least one of a specific frequency or a time of occurrence of the route redirection message.

5. The route monitoring system of claim 1, wherein one of the normalcy rules comprises information associated with a list of known good autonomous system numbers (ASNs).

6. The route monitoring system of claim 1, wherein the service is further executed to convert a protocol of the route redirection message to at least one of a common event format (CEF), a Java script object notation (JSON) format, or an extensible markup language (XML) format.

7. The route monitoring system of claim 1, wherein the remedial actions comprise at least one of generating an alarm, directing the route to a null route, implementing a tracking procedure to determine the source of the malicious route redirection attack, and notifying users of the route.

8. A route monitoring method for a communication network, the method comprising:
receiving, using instructions stored on at least one computer-readable medium and executed by at least one processor, a route redirection message at a communication service provider computing system from a network element in the communication network, the route redirection message including route update information defining a change to a routing rule through the communication network between a customer communication device and a recipient device;
comparing, using the at least one processor, the route update information against one or more normalcy rules associated with potential malicious route redirecting mechanisms; and
generating, using the at least one processor, one or more remedial actions when the comparison of the route update information to the one or more normalcy rules identifies a malicious route redirection attack.

9. The route monitoring method of claim 8, further comprising:
applying a weighting factor to each of a plurality of normalcy rules; and
comparing the route update information with the weighted values of each normalcy rule to identify the route redirection attack.

10. The route monitoring method of claim 8, further comprising comparing the route update information against at least one normalcy rule comprising information associated with known bad IP spaces.

11. The route monitoring method of claim 8, further comprising comparing the route update information against at least one normalcy rule comprising information associated with at least one of a specific frequency or a time of occurrence of the route redirection message.

12. The route monitoring method of claim 8, further comprising comparing the route update information against at least one normalcy rule comprising information associated with a list of known good autonomous system numbers (ASNs).

13. The route monitoring method of claim 8, further comprising converting a protocol of the route redirection message to at least one of a common event format (CEF), a Java script object notation (JSON) format, or an extensible markup language (XML) format.

14. The route monitoring method of claim 8, further comprising performing one or more remedial actions comprising at least one of generating an alarm, directing the routing rule to a null route, implementing a tracking procedure to determine the source of the malicious route redirection attack, and notifying users of the routing rule.

15. A non-transitory computer-readable medium encoded with a route monitoring service comprising instructions executable by a processor to:
receive a route redirection message from a network element in a communication network at a communication service provider computing system, the route redirection message including route update information defining a change to a routing rule through the communication network between a customer communication device and a recipient device;
compare the route update information against one or more normalcy rules associated with potential malicious route redirecting mechanisms; and
generate one or more remedial actions when the comparison of the route update information to the one or more normalcy rules identifies a malicious route redirection attack.

16. The non-transitory computer-readable medium of claim 15, further executed to:
apply a weighting factor to each of a plurality of normalcy rules; and
compare the route update information with the weighted values of each normalcy rule to identify the route redirection attack.

17. The non-transitory computer-readable medium of claim 15, further executed to compare the route update information against at least one normalcy rule comprising information associated with known bad IP spaces.

18. The non-transitory computer-readable medium of claim 15, further executed to compare the route update information against at least one normalcy rule comprising information associated with at least one of a specific frequency or a time of occurrence of the route redirection message.

19. The non-transitory computer-readable medium of claim 15, further executed to compare the route update information against at least one normalcy rule comprising information associated with a list of known good autonomous system numbers (ASNs).

20. The non-transitory computer-readable medium of claim 15, further executed to perform one or more remedial actions comprising at least one of generating an alarm, directing the routing rule to a null route, implementing a tracking procedure to determine the source of the malicious route redirection attack, and notifying users of the routing rule.
